(19) United States
(12) Patent Application Publication
(10) Pub. No.: US 2004/0011216 A1
(43) Pub. Date: Jan. 22, 2004

(54) Better butter kontainer

(76) Inventor: Betty Marie Jodrey, Bethel, OH (US)

Correspondence Address: Betty Marie Jodrey, 2169 Bethel - Hygiene Rd, Bethel, OH, 45106, US

(21) Appl. No.: 10/459,917

(22) Filed: Jun. 12, 2003

Related U.S. Application Data
(60) Provisional application No. 60/389,062, filed on Jun. 14, 2002.

(51) Int. Cl. A23L 1/00

(52) U.S. Cl. 99/348

(57) ABSTRACT

Better Butter Kontainer—a device for storing and measuring stick butter; consists of two pieces—a tray and a cover; tray is imprinted with numbers and lines to assist in the measuring the amount of butter, needed when baking, cooking, or eating servings of butter; tray is divided into nine equal divisions; a stick of butter has eight tablespoons; lines on tray are numbered from each end so the stick of butter can be placed from either end of the tray; user can see all the numbers clearly; each side of the tray has additional markings imprinted to help user know that EACH LINE equals 1 TABLESPOON and ¼ CUP—4 TBSP. ⅓ CUP—5⅓ TBSP. ½ CUP—8 TBSP; markings allow the user to throw away wrapper butter is wrapped in when purchased by consumer; cover of Better Butter Kontainer has a unique feature—an indention for butter knife to rest; device allows persons to use butter with precise measurements for better health, and no hassle, or mess.

### CROSS-REFERENCE TO RELATED APPLICATIONS

This patent is for an improvement upon the Butter Cutter Pat. No. 6,505,536 filed Jan. 14, 2003 invented by Paul F. Wilhelm.

Provisional Patent No. 60/389,062 for the Better Butter Kontianer filed on Jun. 14, 2002. A copy of that Provisional Patent is included with this information.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to stick butter dishes which have been around for many years. Stick butter dishes in the past have been used to store the stick butter once the wrapper has been discarded. Also, stick butter dishes have been made to compliment the china and used to adorn the dining table at meal time. I have found only one other stick butter container that had measurements and that was the Butter Cutter Pat. No. 6,505,536 granted on Jan. 14, 2003. However, this patented product differs from the Better Butter Kontianer in that the measurements are marked on the cover of that container while the Better Butter Kontainer has the markings on the tray. Also, the Butter Cutter has a blade to cut the butter which differs from the present invention in which a butter knife would be used to extract the amount of butter one needed. The blade of the Butter Cutter is encased in the container and used to cut off the portion of butter needed. Any cutting tool presents a hazard. A butter knife would be used in extracting portions of butter from the Better Butter Kontainer, but the user can see the whole stick of butter and be in better control of the knife than they would be of the Butter Cutter where the butter is in a receptacle and blade is encased inside the container.

### BRIEF SUMMARY OF THE INVENTION

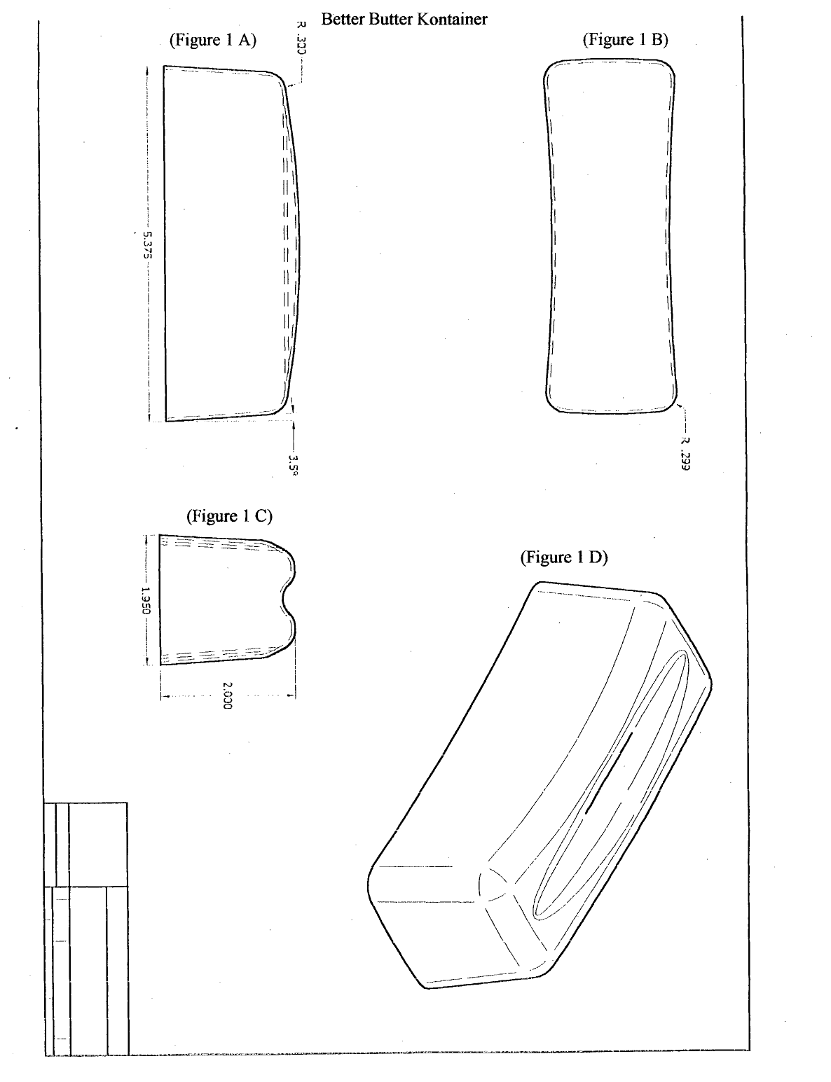

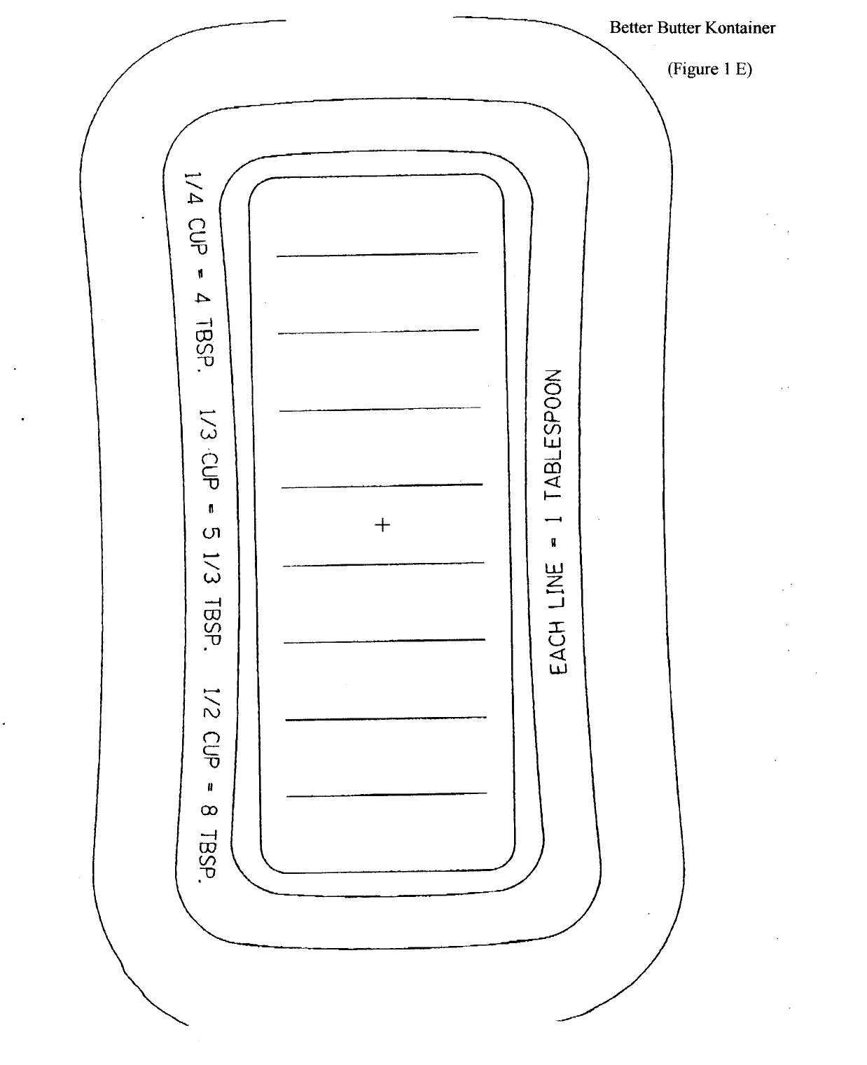

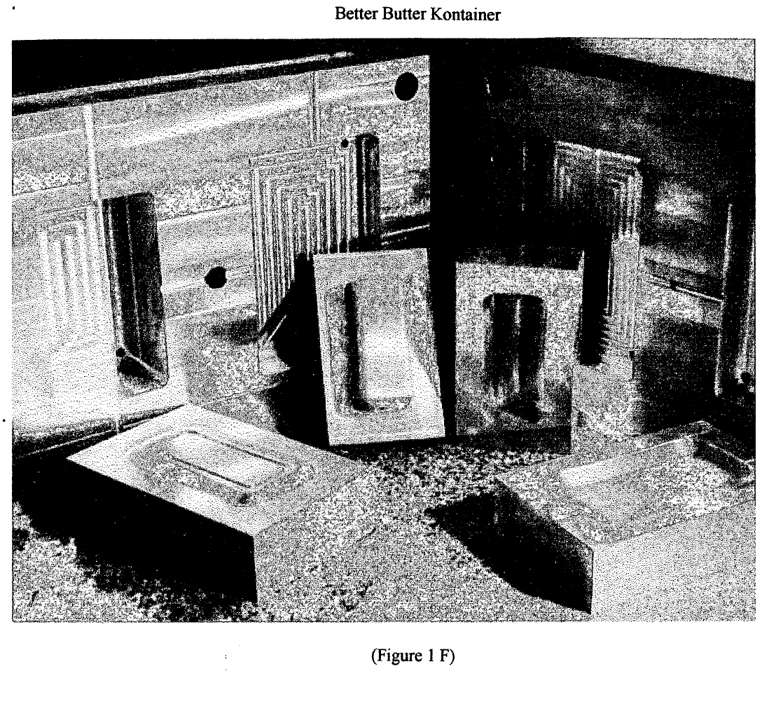

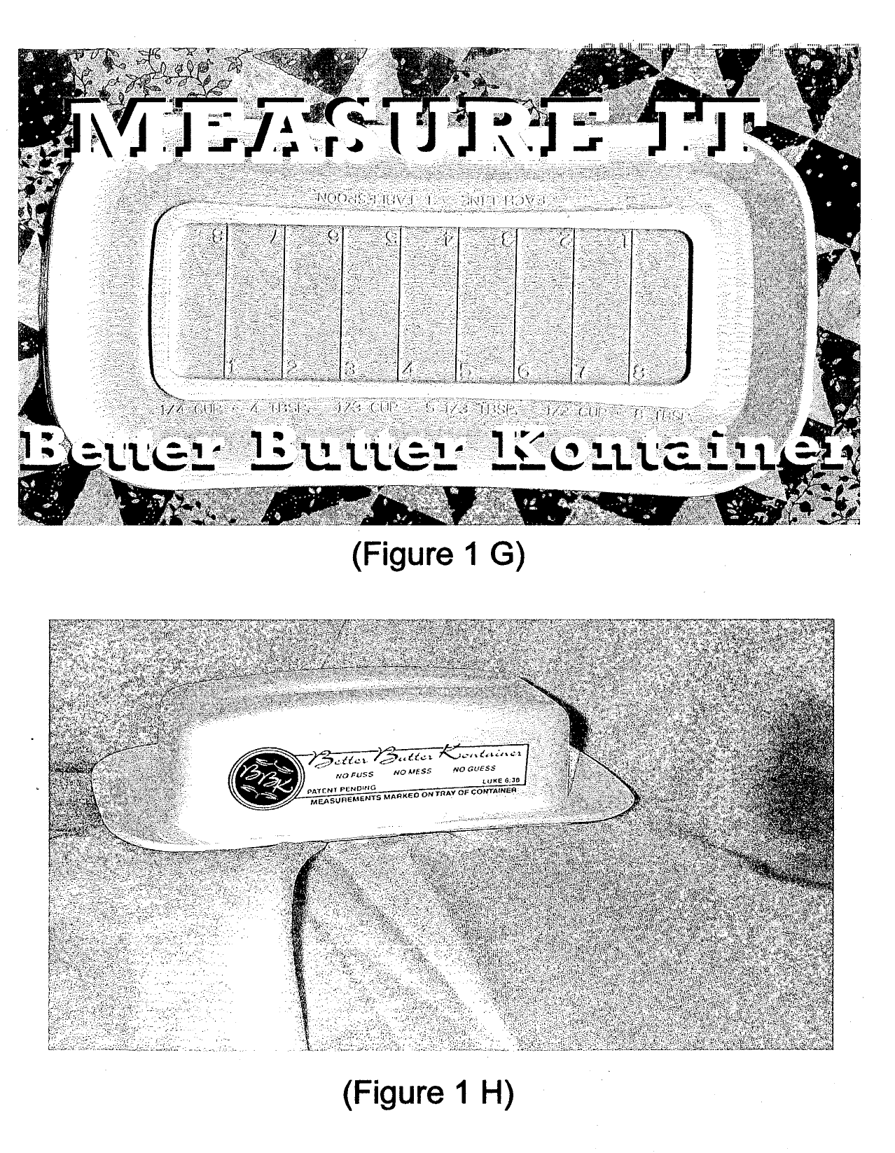

The purpose of the Better Butter Kontainer is to store a stick of butter and still have the measurements available. With the present invention, one can unwrap the butter, or margarine and place it on the tray of the Better Butter Kontainer and still have accurate measurements available to them when baking, cooking, or for buttering toast, muffins, bread, etc. Unlike the Butter Cutter (Pat. No. 6,505,536) which has tablespoon and cup increments marked on the cover, the tray of the Better Butter Kontianer is imprinted with tablespoon markings for a standard stick of butter (¼ pound). There are nine divisions marked on the tray. A stick of butter contains eight tablespoons. The nine markings allows the user to lay the stick of butter from either end of the tray. On each side of the tray, there are additional markings imprinted (FIG. 1G). One side is imprinted with EACH LINE—1 TABLESPOON. The other side of the tray is imprinted with 1/4 CUP—4 TBSP. ⅓ CUP —5⅓ TBSP. ½ CUP—8 TBSP. These markings of the Better Butter Kontainer alleviate the mess accompanied with re-wrapping stick butter, or margarine in the wrapper and saving the wrapper for measurements. The Better Butter Kontainer is also a tool that allows a person concerned with nutrition to use only the amount of butter needed per serving. This is very helpful since one tablespoon of butter has 100 calories. The top of the cover of the Better Butter Kontainer has an indention which can be use to rest the butter knife so the butter knife is kept off the preparation area, or the table linen.

### BRIEF DESCRIPTION OF THE SEVERAL VIEW OF THE DRAWING

(FIG. 1A) Shows a side view of the cover for the Better Butter Kontianer. It shows the gradual indention, for resting the butter knife, on the top with the dotted lines. The length of the cover is 14 cm.; width is 5 cm.; and height is 4 cm. This view also shows a good picture of the rounded corners at each end.

(FIG. 1B) Shows the drawing of the tray of the Better Butter Kontainer without the markings. The tray is 19.5 cm. in length when measuring from the center; and 10.5 cm. in width in the center; and 11.5 cm. in width at the ends. There is a gradual incline from each end of the tray to the center.

(FIG. 1C) Shows the end view of the cover for the Better Butter Kontainer. The dotted lines show how the rounded corners go from top to bottom. The indention on the top is emphasized in this view. The width from where the corners are rounded is 6.5 cm. and height is 4 cm.

(FIG. 1D) Shows a three-dimensional view of the cover of the Better Butter Kontainer. It is 14 cm. in length; 5 cm. in width; and 4 cm. in height. The cover also has an indention which runs gradually from each end to the center with a 0.4 cm. depth in the middle. Again, this indention is where the butter knife can rest. This view also shows the nice rounded corners of the cover.

((FIG. 1E) Shows the marking increments on the bottom tray of the Better Butter Kontainer. The tray is divided into nine equal spaces with each space representing one tablespoon. However this view does not show numbers written by the nine spaces. The view does show the markings on the side of the tray—¼ CUP—4 TBSP.; ⅓ CUP—5⅓ TBSP.; and ¼ CUP—TBSP. On the opposite side of the tray, one can see the marking EACH LINE—1 TABLESPOON. The view also shows the rounded corners.

(FIG. 1F) Shows a picture of an injection mold which is one type of mold that could be used in making the Better Butter Kontainer. This gives another view of how the tray and cover of the Better Butter Kontainer look. One can better see the rounded corners and the lip of the tray as well as the indention of the cover from the underneath side..

(FIG. 1G) This is an actual picture of the tray of the Better Butter Kontainer taken with a digital camera. It shows the numbers for the eight tablespoons. Note that there are nine spaces, but the butter can be placed from either end of the container so the user can view the markings without having to turn the tray around. The markings EACH LINE—1 TABLESPOON and ¼ CUP.—4 TBSP.; ⅓ CUP—5⅓ TBSP; and ½ CUP—8 TBSP. can be seen in this picture.

(FIG. 1H) This is a digital picture showing how the Better Butter Kontainer would look as a whole unit sitting on a table. The indention of the cover is visible so one can see where the butter knife would rest. Note that the label would be removed. It is applied to the Better Butter Kontainer for marketing purposes.

### DETAILED DESCRIPTION OF THE INVENTION

Stick butter containers have been available to store stick butter, or margarine for many years. The Better Butter Kontainer is unique and different from the standard butter containers of the past. The unique feature of the Better Butter Kontainer is the markings imprinted on the tray of the container where the butter, or margarine is placed. In the past, one would have to use the markings found on the wrapper of the butter in order to get precise measurements for tablespoons, or for the number of tablespoons needed for ¼ cup, ⅓ cup, and ½ cup. This process of measurement becomes messy and difficult once the wrapper is opened and re-closed and precise measurements cannot be made. Many times the sticks of butter and margarine are not wrapped to precisely show all the tablespoons. The Better Butter Kontainer eliminates the hassle and need for keeping the butter wrapper. Once the butter is unwrapped, it can be placed on the tray and exact measurements for baking, cooking, or general servings can be easily obtained with only the use of a butter knife. Since the cover of the Better Butter Kontainer has the indention, the butter knife can easily rest there when it is not being used. FIG. 1C, FIG. 1D and FIG. 1H show a view of this indention where the butter knife can be placed. In doing a patent search, I found the invention of the Butter Cutter (Pat. No. 6,505,536) invented by Paul F. Wilhelm Jan. 14, 2003 was the first butter container to have measurement markings imprinted. However, the Butter Cutter differs from the Better Butter Kontainer in that the Butter Cutter has markings on the cover portion of the container while the Better Butter Kontainer has the markings on the tray of the container. The Better Butter Kontainer is safer for use because it does not have a blade involved as does the Butter Cutter. A butter knife does have to be used when extracting butter from the Better Butter Kontainer, but one can better grip and be in control of a knife than they could be with a blade which is encased inside a covering like the Butter Cutter. The Butter Cutter also requires the person to use force and push the butter forward in the receptacle mechanism and press the blade forward in order to obtain the portion of butter needed. For persons with arthritic conditions, this process could be difficult, or even impossible. The Better Butter Kontainer can be used safely by intermediate age children when they assist in the kitchen. Again, the force needed to operate the Butter Cutter and the blade action could be difficult and unsafe for younger hands. The Better Butter Kontainer allows for the whole stick of butter to be visible (FIG. 1G) so the person can see exactly what lines to follow in order to cut the amount of butter needed with a butter knife. Another hazard of the Butter Cutter is the cleaning of the blade. Any oily, or greasy substance, and butter is one of those substances, is difficult to clean off a blade, or knife. One could injure themselves trying to clean the blade of the Butter Cutter. A butter knife which would be used in connection with the Better Butter Kontainer is easily washed with soap and water. The cleaning process also results in whether the utensil is sanitary. The Butter Cutter as is the Better Butter Kontainer can be made of materials that are dishwasher safe. However, not every household owns a dishwasher. Therefore, the Better Butter Kontainer would be more sanitary since it could be easily washed along with the knife in hot, soapy water without the fear of injury to the person. FIG. 1G of the Better Butter Kontainer clearly shows the markings for tablespoons, and the various increments needed for ¼ cup, ⅓ cup, and ½ cup. By having the markings clearly imprinted on the tray, one can throw away the stick butter wrapper and still be able to extract accurate measurements. The Better Butter Kontainer can be made of a variety of materials such as plastic, glass, stainless steel, and china. It could also be made of various colors to compliment the many table settings available. Also, the Better Butter Kontainer provides the dinner guest with accurate measurements to control servings used when dining at the table. The control of fat intake is practiced by many people with health conditions. The Better Butter Kontainer is a kitchen tool that can be used to assist persons in living healthier lives. The Better Butter Kontainer also provides an attractive accessory for the dining area (FIG. 1H). The Butter Cutter would be more complicated to use and less attractive on the dinning table.

1. I claim that my invention, the Better Butter Kontainer is a device for storing and measuring stick butter, or margarine.
The device is composed of two pieces—a tray where the stick butter, or margarine is placed and a cover to place over the butter, or margarine:

2. The device of claim 1 has the tray imprinted with markings for measuring the eight tablespoons found in a stick of butter, or margarine.
There are nine equal divisions on the tray which allows the user to place the butter, or margarine from either end of the tray and still be able to see tablespoon measurement markings clearly.

3. The device of claim 1 has the measurement marking imprinted on the side of the tray for the number of tablespoons of butter or margarine needed for cup measurements—¼ CUP—4 TBSP ⅓ CUP—5⅓ TBSP ½ CUP—8 TBSP.
The cup/tablespoon markings alleviates the need for keeping the wrapper in which sticks of butter and margarine are wrapped.

4. The device of claim 1 has the words imprinted on one side of the tray to tell the user the number of tablespoons for each division on the tray—EACH LINE—1 TABLESPOON

5. The device of claim 1 is the first stick butter, or margarine container to have. measurement markings imprinted on the tray of a stick butter container.

6. The device of claim 1 has a cover which has an indention in the top where the butter knife can be placed when it is not in use.
The butter knife rest in the cover helps to keep the butter knife off the food preparation area and off the table, or linen making for more sanitary conditions.
